(19) United States
(12) Patent Application Publication
(10) Pub. No.: US 2009/0139818 A1
(43) Pub. Date: Jun. 4, 2009

(54) Torque converter

(75) Inventors: Kazunori Ishikawa, Toyota-shi (JP); Akitomo Suzuki, Anjo-shi (JP); Kazuyoshi Ito, Anjo-shi (JP); Takamitsu Kuroyanagi, Anjo-shi (JP); Hiroki Nagai, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO. , LTD. ,, Anjo-shi (JP)

(21) Appl. No.: 12/292,519

(22) Filed: Nov. 20, 2008

(30) Foreign Application Priority Data
Nov. 30, 2007 (JP) 2007-311517

(51) Int. Cl. F16D 33/00

(52) U.S. Cl. 192/3.29

(57) ABSTRACT

In sliding engagement of a clutch plate of a lock-up clutch with a front cover of a converter housing, with a difference in rotational speed therebetween, the sum of the urging force of a coil spring and the force of a lock-up discharge hydraulic pressure in a front side chamber is greater than the force of a lock-up engagement pressure in a rear side chamber. A selector valve member, accommodated in a valve chamber of a displacement selector mechanism, therefore, brings an oil chamber between the clutch plate (first piston) and a second piston into communication with the front side chamber. The hydraulic pressure of the rear side chamber received by a rear face of the piston is higher than hydraulic pressure of the oil chamber received by a front face of the piston and, therefore, the piston is displaced forwardly into frictional contact with the clutch plate and transmission of judder to an input shaft of a speed change mechanism is thereby reduced.

### INCORPORATION BY REFERENCE

The disclosure of Japanese Patent Application No. 2007-311517 filed on Nov. 30, 2007, including the specification, drawings and abstract is incorporated herein by reference in its entirety.

### BACKGROUND OF THE INVENTION

1. Field of the Invention

The present invention relates to a torque converter equipped with a lock-up clutch.

2. Description of the Related Art

A vehicle having an automatic transmission typically uses a torque converter to transmit torque of an engine by smooth engagement with a speed change mechanism in starting movement of the vehicle. The torque converter includes, for example, a converter housing, a pump impeller, and a turbine runner. The converter housing is connected to an output shaft of the engine and the pump impeller is connected to the converter housing. The turbine runner is connected to an input shaft of the speed change mechanism in opposition to (facing) the pump impeller. The torque converter is filled with an automatic transmission fluid (ATF).

The pump impeller rotates with the converter housing as the output shaft of the engine rotates, and thereby transmits torque, through flow of the ATF, from the pump impeller to the turbine runner. The turbine runner receives the force of the flow of the ATF which causes it to rotate and rotatably drive the input shaft of the speed change mechanism, so that the torque of the engine is thereby transmitted to the speed change mechanism.

While a torque converter can transmit rotation of the engine smoothly to the speed change mechanism in starting movement, because the power transmission is through the ATF, a loss of energy transmission occurs after starting. Therefore, such a torque converter typically includes a lock-up clutch placed between the converter housing and the turbine runner (see, for example, Japanese Patent Application Publication No. JP-A-2005-188662). The lock-up clutch mechanically directly connects (couples) the output shaft of the engine with the input shaft of the speed change mechanism.

Clutch control may at times be provided for the lock-up clutch in the torque converter such that the lock-up clutch is placed in a sliding engagement state (slip) in which the lock-up clutch makes a sliding contact with (i.e., slips on) the converter housing allowing relative rotation therebetween, followed by a completely engaged state in which the lock-up clutch frictionally engages the converter housing for integral rotation therewith. Such a clutch control for sliding engagement extends the range of engagement of the lock-up clutch. Thus, the clutch control is executed as an intermediate state between a non-engagement state in which the lock-up clutch is spaced apart from the converter housing and the completely engaged state.

In the sliding engagement state of the lock-up clutch, however, the lock-up clutch rotates while making a sliding contact with the converter housing. This tends to cause what is called “judder” which is vibration transmitted from the lock-up clutch to the speed change mechanism via the turbine runner, giving the driver a sense of discomfort.

### SUMMARY OF THE INVENTION

In view of the above, the present invention provides a torque converter capable of reducing transmission of judder, generated in the sliding engagement state, to the speed change mechanism.

According to a first aspect, the present invention provides a torque converter which includes: a converter housing connected to an output shaft of a drive source (e.g. internal combustion engine “ICE”); a pump impeller connected to the converter housing; a turbine runner connected to an input shaft of a speed change mechanism in opposition to the pump impeller; a lock-up clutch disposed between the turbine runner and the converter housing for directly connecting the output shaft and the input shaft when fully engaged; and a frictional contact mechanism, for frictional contact with the piston of the lock-up clutch, in a sliding engagement (slip) state with the converter housing, allowing relative rotation therebetween.

When the lock-up clutch is in the sliding engagement state, a piston (second piston) of the frictional contact mechanism makes frictional contact with the piston (first piston) of the lock-up clutch and judder generated by the lock-up clutch in its sliding engagement state is thereby dissipated as friction energy and dampened. Transmission of the judder generated by the sliding engagement of the lock-up clutch to the speed change mechanism is therefore reduced.

According to a second aspect of the present invention, when the lock-up clutch is in a completely engaged state, with the first piston in frictional contact with the converter housing and integrally rotatable therewith, the second piston of the frictional contact mechanism is spaced apart from, i.e. in a non-contact state relative to, the first piston of the lock-up clutch.

However, if the second piston of frictional contact mechanism, which functions as a damping mechanism, is in frictional contact with the first piston of the lock-up clutch in the completely engaged state of the lock-up clutch, torque fluctuations based on vibration of the engine or other drive source are transmitted to the speed change mechanism via the frictional contact mechanism from the lock-up clutch, which poses a problem of a so-called booming noise. Accordingly, the second piston of frictional contact mechanism is spaced apart from, i.e. in a non-contact state relative to, the first piston of the lock-up clutch in the completely engaged state of the lock-up clutch. This allows the input of the torque fluctuations, due to combustion within the engine or other drive source, and transmitted to the speed change mechanism via the frictional contact mechanism from the lock-up clutch, to be reduced and, therefore, the so-called booming noise to be reduced.

According to a third aspect of the present invention, the frictional contact mechanism includes: the second piston that is displaceable between an engaged position in which it is in frictional contact with the first piston of the lock-up clutch, and a disengaged in position which it is spaced apart from its engagement position; and a displacement selector mechanism that controls the positioning of the second piston by applying a hydraulic pressure, of hydraulic fluid flow through the torque converter, to the second piston member during operation of the lock-up clutch.

In accordance with this arrangement, the second piston can be moved by pressure between its engaged position in frictional contact with the first piston of the lock-up clutch, and its disengaged position in which it is spaced apart from its engaged position, by effectively using the hydraulic pressure of the hydraulic fluid flowing through the torque converter during operation of the lock-up clutch. Thus, the second piston can be easily displaced between its engaged position and its disengaged position, without need for any electric control mechanism, based on a pressure difference between the hydraulic pressure of the hydraulic fluid acting from the side of the engaged position and the hydraulic pressure of the hydraulic fluid acting from the side of the disengaged position.

According to a fourth aspect of the present invention, the displacement selector mechanism brings an oil chamber containing hydraulic fluid pressure, which acts on the second piston to urge it toward its disengaged position, into communication with a lock-up engagement pressure region when in the sliding engagement state of the lock-up clutch and with a lock-up discharge pressure region when in the completely engaged state of the lock-up clutch.

In accordance with this arrangement, the hydraulic pressure of the hydraulic fluid pressing the second piston toward its disengaged position becomes a lock-up discharge pressure when the lock-up clutch is in its sliding engagement state and a lock-up engagement pressure when the lock-up clutch is in its completely engaged state. Additionally, the hydraulic lock-up engagement pressure acts at all times on the second piston to urge it toward its engaged position. In the sliding engagement state of the lock-up clutch, therefore, the second piston is pressed by the lock-up engagement pressure on a high pressure side and thereby forced into its engaged position in frictional contact with the first piston of the lock-up clutch. In the completely engaged state of the lock-up clutch, on the other hand, the same hydraulic pressure, i.e. the lock-up engagement pressure, acts on the second piston from both the side of the engaged position and the side of the disengaged position, so that the second piston is not displaced by hydraulic pressure. In this case, however, the first piston of the lock-up clutch, having received the same lock-up engagement pressure, is displaced so as to be spaced from the second piston, whereby the second piston assumes a non-contact state relative to the first piston of the lock-up clutch.

According to a fifth aspect of the present invention, the displacement selector mechanism includes: a valve chamber from which branch both the lock-up engagement pressure region and the lock-up discharge pressure region, i.e. the valve chamber communicates with both of the two regions; a selector valve member disposed in the valve chamber for movement between an engagement pressure communication position in which the valve chamber is in communication with the lock-up engagement pressure region, and a discharge pressure communication position in which the valve chamber is in communication with the lock-up discharge pressure region, while receiving, from mutually opposing directions, the hydraulic pressure of the lock-up engagement pressure region and the hydraulic pressure of the lock-up discharge pressure region. A biasing member, e.g. spring under compression, cooperates with the hydraulic pressure of the lock-up discharge pressure region in urging the selector valve member in the direction of the discharge pressure communication position. The force of the biasing member is set so that, when the lock-up clutch is in its sliding engagement state, the sum of the force of the biasing member and the force of the hydraulic pressure of the lock-up discharge pressure region is greater than the force of the hydraulic pressure of the lock-up engagement pressure region. When the lock-up clutch is in its the completely (fully) engaged state, on the other hand, the force of the hydraulic pressure of the lock-up engagement pressure region is greater than the sum of the urging force of the biasing member and the force of the hydraulic pressure of the lock-up discharge pressure region.

In accordance with this arrangement, in the sliding engagement state of the lock-up clutch, the sum of the urging force of the biasing member urging the selector valve member in the direction of the discharge pressure communication position and the force of the lock-up discharge pressure becomes greater than the force of the lock-up engagement pressure urging the selector valve member in the direction of the engagement pressure communication position. Since the selector valve member is positioned at the discharge pressure communication position, therefore, the hydraulic pressure of the oil chamber causing the hydraulic pressure to act on the second piston from the engagement position side becomes the lock-up discharge pressure, so that the second piston is forced by the lock-up engagement pressure on the high pressure side to the engagement position. When the lock-up clutch is in its completely engaged state, on the other hand, the force of the lock-up engagement pressure urging the selector valve member in the direction of the engagement pressure communication position becomes greater than the sum of the force of the biasing member and the force of the lock-up discharge pressure. The selector valve member is therefore positioned at the engagement pressure communication position, so that the hydraulic pressure of the oil chamber causing the hydraulic pressure acting on the second piston from the side of the engagement position becomes the lock-up engagement pressure. The same hydraulic lock-up engagement pressure from both the side of the engagement position and the side of the non-engagement position acts on the second piston and, therefore, the second piston is not displaced by the hydraulic pressure. At that point in time, however, the first piston of the lock-up clutch that receives the lock-up engagement pressure is displaced so as to be spaced from the second piston, so that the second piston is then in a non-contact state relative to the lock-up clutch.

### BRIEF DESCRIPTION OF THE DRAWINGS

FIG. 1 is a longitudinal cross-sectional view of a torque converter according to an embodiment of the present invention with the lock-up clutch disengaged;

FIG. 2 is a longitudinal cross-sectional view of the torque converter of FIG. 1 with the lock-up clutch being in a sliding engagement state (slipping); and

FIG. 3 is a longitudinal cross-sectional view of the torque converter of FIG. 1 with the lock-up clutch completely engaged.

### DETAILED DESCRIPTION OF THE PREFERRED EMBODIMENTS

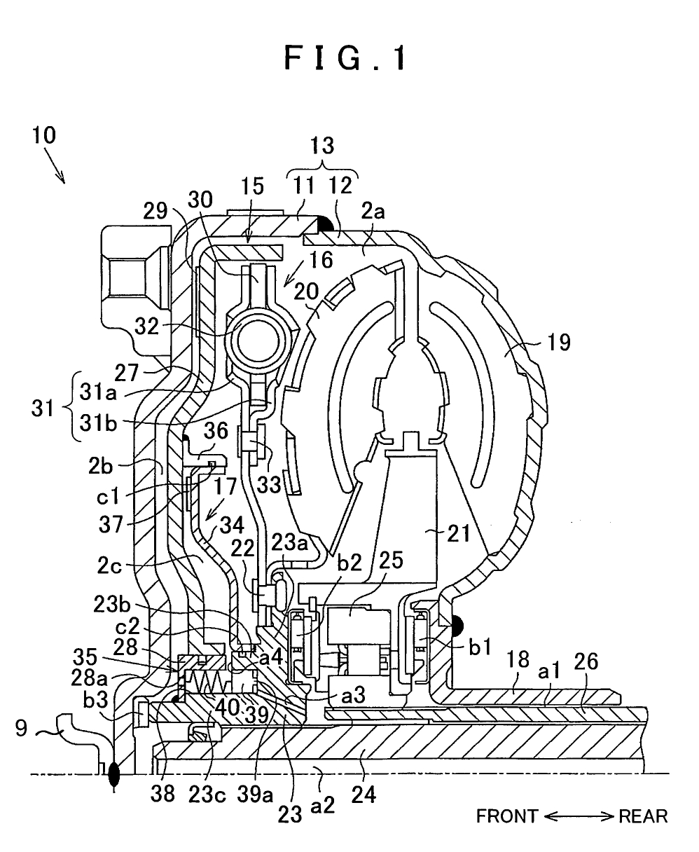

A torque converter according to an embodiment of the present invention is described below with reference to FIGS. 1 through 3. In the description that follows, “front-rear direction” refers to the front-rear direction indicated by the arrow shown in FIGS. 1 through 3.

Referring to FIG. 1, a torque converter 10 includes a converter housing 13 that is formed from a front cover 11 and a pump cover 12. The front cover 11 is connected to an output shaft 9 of an engine. The pump cover 12 is fixed by welding to an outer peripheral side of the front cover 11. A lock-up clutch 15, a damper unit 16, and a friction contact mechanism 17 are housed inside the converter housing 13. The converter housing 13 is filled with a hydraulic fluid, i.e. an automatic transmission fluid (ATF).

The front cover 11 has a substantially cylindrical shape, having a closed front side (“bottom wall”) and an open rear side. The output shaft 9 of the engine is connected at a substantially central point of the bottom wall (radially extending portion) of the front cover 11, so that the front cover 11 is rotatably driven by the output shaft 9 of the engine. The pump cover 12 has a substantially circular shape and closes the rear side opening of the front cover 11. A cylindrical support cover 18 is connected to a drive shaft of an oil pump of the automatic transmission (not shown) and is fixed to the center of the pump cover 12. Rotation of the output shaft 9 of the engine is transmitted to the oil pump via the front cover 11, the pump cover 12, and the support cover 18.

Additionally, referring to FIG. 1, a pump impeller 19, having the shape of a vane wheel, is fixed to the front side of the pump cover 12 (the side thereof facing the front cover 11) inside the converter housing 13, so as to integrally rotate with the pump cover 12 and the front cover 11. In addition, a turbine runner 20 having the shape of a vane wheel, is disposed inside the converter housing 13 in opposition to the pump impeller 19 in the front-rear direction with its inner periphery connected to a flange portion 23a of a turbine hub 23 with a pin 22. The turbine runner 20 is thereby integrally rotatable with the input shaft 24 of the automatic transmission, to which the turbine hub 23 is spline-fitted.

A stator 21 is disposed between the pump impeller 19 and the turbine runner 20, inside the converter housing 13. The stator 21 includes a one-way clutch 25 disposed therein which functions to limit rotation to one direction only. The stator 21 uses the one-way clutch 25 to adjust the direction of flow of the ATF inside the converter housing 13 of the torque converter 10, based on a difference in speed between the pump impeller 19 and the turbine runner 20.

The one-way clutch 25 is spline-fitted to a stator shaft 26 having a rear end portion fixed to the drive shaft of the oil pump. Further, the one-way clutch 25 has its front and rear sides supported, respectively, by the turbine hub 23 and the support cover 18 via thrust bearings b1, b2. An oil passage a1 communicating with the oil pump is formed between the stator shaft 26 and the support cover 18 and communicates with a space 2a inside the converter housing 13 by way of the thrust bearing b1 disposed between the support cover 18 and the one-way clutch 25.

The lock-up clutch 15 is disposed between the front cover 11 and the turbine runner 20, inside the converter housing 13. The lock-up clutch 15 provides direct connection between the output shaft of the engine and the input shaft 24 of an automatic speed change mechanism when fully engaged. The lock-up clutch 15 has a clutch plate 27 (first piston), having a circular ring shape, which serves as the lock-up clutch piston, and which is formed from sheet metal. The clutch plate 27 has its inner periphery spline-fitted to an outer peripheral surface of a valve body 28. The valve body 28 has a substantially cylindrical shape with a closed end (bottom) that is welded to a shaft portion 23c of the turbine hub 23, and serves as a component of the frictional contact mechanism 17. The clutch plate 27 is thereby axially movable toward and away from the rear face of the front cover 11, but locked against rotation. A friction member 29 is fixed in a radially outward position on the front face of the clutch plate 27, facing the rear face of the front cover 11. The clutch plate 27 (first piston) can be brought into frictional contact with the front cover 11 as necessary.

The damper unit 16 includes a drive plate 30, a driven plate 31, and a damper spring 32. The drive plate 30, of a circular ring shape, is connected to the engine side. The driven plate 31, of a disc shape, is connected to the speed change mechanism side. The damper spring 32, mounted between the two plates 30 and 31, transmits the force of rotation (torque) of the drive plate 30 to the driven plate 31. The drive plate 30 has a lock tab (not shown) formed near its outer periphery, the lock tab being locked in a lock hole (not shown) formed in an outer peripheral portion of the clutch plate 27, so that the drive plate 30 is fixed against relative rotation, while being axially movable relative to the clutch plate 27.

The driven plate 31 is composed of a pair of plate members 31a, 31b that support the drive plate 30 by clamping it from axially opposite sides. The pair of plate members 31a, 31b is fastened together with a pin 33 where the plate members radially overlap. Further, an inner peripheral portion of the plate member 31 a is connected to the turbine runner 20 and to the flange portion 23a of the turbine hub 23, which is spline-fitted to the input shaft 24 of the automatic speed change mechanism, by means of a pin 22.

The damper spring 32 is accommodated in a slot-like accommodation space formed between the pair of plate members 31a, 31b and is arranged with a longitudinal first end abutting the drive plate 30 and a longitudinal second end abutting the driven plate 31. Accordingly, the rotation of the output shaft of the engine is transmitted to the drive plate 30 via the clutch plate 27 and from the drive plate 30 to the driven plate 31 via the damper spring 32. When the clutch plate 27 is in contact with (sliding engagement or completely engaged) the front cover 11 via the friction member 29, the rotation from the output shaft of the engine is transmitted to the input shaft 24 of the automatic speed change mechanism via the drive plate 30, the damper spring 32, and the driven plate 31 of the damper unit 16.

The input shaft 24 of the automatic speed change mechanism is rotatably supported by the stator shaft 26. The input shaft 24 has a leading end portion spline-fitted to the inner periphery of the turbine hub 23, and therefore rotates integrally with the turbine hub 23. The input shaft 24 has a central, axially extending oil passage a2 providing communication between the oil pump and a space 2b between the front cover 11 and the clutch plate 27, via a thrust bearing b3 disposed between the rear face of the front cover 11 and a front end of the shaft portion 23c of the turbine hub 23. The space 2b located forwardly of the clutch plate 27 in the converter housing 13 is hereinafter referred to as “front side chamber 2b” and the space 2a located rearwardly thereof is hereinafter referred to as “rear side chamber 2a”.

The lock-up clutch 15 is disengaged, as shown in FIG. 1, by supplying the ATF, at a lock-up off pressure, from the oil pump to the front side chamber 2b, via the oil passage a2 and the thrust bearing b3, thereby moving the clutch plate 27 rearwardly, and separating the friction member 29 from contact with the rear face of the front cover 11. For disengagement, the ATF at the lock-up off pressure supplied to the front side chamber 2b is discharged therefrom into the rear side chamber 2a; the ATF is then discharged to an oil pan (not shown) via the thrust bearing b1 and the oil passage a1.

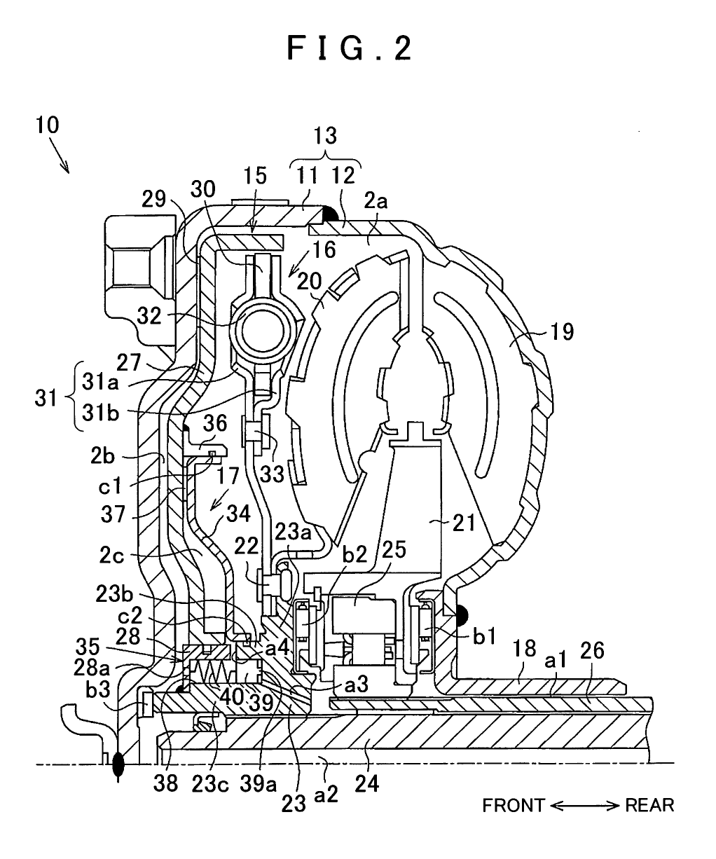

The slipping state of the lock-up clutch 15, as shown in FIG. 2, is achieved by supplying the ATF at a lock-up on pressure (hereinafter also referred as “lock-up engagement pressure”) from the oil pump to the rear side chamber 2a, via the oil passage al and the thrust bearing b1, to press the clutch plate 27 forwardly and thereby cause the friction member 29 to come into contact with the rear face of the front cover 11. The ATF at the lock-up engagement pressure in the rear side chamber 2a is discharged to the front side chamber 2b and then to the oil pan via the thrust bearing b3 and the oil passage a2. The clutch plate 27, however, is gradually pressed forward so that the net result is only a slight difference in hydraulic pressure between the front side chamber 2b and the rear side chamber 2a. Stated differently, the magnitude of the lock-up engagement pressure, supplied via the oil passage a1 and the thrust bearing b1, is adjusted so that the hydraulic pressure within the rear side chamber 2a, which receives the ATF at the lock-up engagement pressure, is slightly higher than the lock-up discharge pressure within the front side chamber 2b. Thus, when the lock-up clutch 15 is to be engaged, the front side chamber 2b functions as a lock-up discharge pressure region, while the rear side chamber 2a functions as a lock-up engagement pressure region. Thus, when the clutch plate 27 receives the hydraulic pressure of the rear side chamber 2a, which is slightly higher than the hydraulic pressure of the front side chamber 2b, the lock-up clutch 15 is brought into the sliding engagement state (also referred to as a slip engagement state), in which the friction member 29 of the clutch plate 27 makes sliding contact with the front cover 11 with a difference in rotation therebetween.

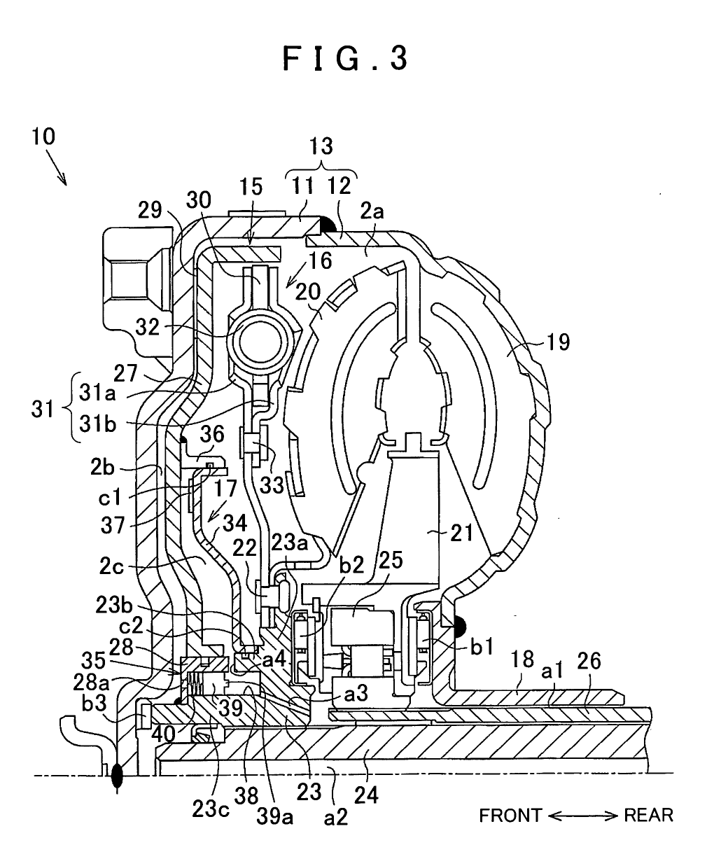

In the completely engaged state of the lock-up clutch 15 shown in FIG. 3, the ATF at a pressure higher than that in the sliding engagement state is supplied to the rear side chamber 2a via the oil passage a1 and the thrust bearing b1. As a result, the hydraulic pressure of the ATF introduced into the rear side chamber 2a causes the clutch plate 27 to make solid frictional contact with the front cover 11 via the friction member 29, to thereby become integrally rotatable with the front cover 11, i.e. to achieve the completely engaged state. In this case, the hydraulic pressure of the ATF in the front side chamber 2b serving as the lock-up discharge pressure region, drops to a lower pressure relative to the hydraulic pressure of the ATF in the rear side chamber 2a which suddenly thereby becomes the lock-up engagement pressure region, since communication therebetween is shutoff by engagement between the friction member 29 and the front cover 11.

The frictional contact mechanism 17 will now be described in detail below.

Referring to FIG. 1, the frictional contact mechanism 17 includes a substantially disk-shaped piston (second piston) 34 and a displacement selector mechanism 35. The piston 34 is axially movable between an engaged position (the position shown in FIG. 2), in which the piston 34 makes frictional contact with the clutch plate 27 of the lock-up clutch 15, and a disengaged position (the position shown in FIG. 3), spaced rearwardly from the engagement position. The displacement selector mechanism 35 positions the piston 34 using the hydraulic pressure of the ATF.

The piston 34 has an outer peripheral edge, spline-fitted to a circular ring-shaped support member 36 which extends rearwardly from the rear face of the clutch plate 27, and an inner peripheral edge, spline-fitted to a cylindrical portion 23b which protrudes forwardly from the flange portion 23a of the turbine hub 23. The piston 34 is thereby axially movable relative to the turbine hub 23 and the clutch plate 27, while being locked against rotation. A friction member 37 is fixed to the front face side of piston 34, near the outer periphery thereof, facing the rear face of the clutch plate 27. When in the engaged position, the piston 34 (second piston) is in frictional contact with the clutch plate 27 (first piston) via the friction member 37.

As shown in FIG. 1, an oil chamber 2c is formed between the rear face of the clutch plate 27 and the front face of the piston 34. The hydraulic pressure of the ATF introduced into the oil chamber 2c acts on the piston 34 for movement from the front side, engaged position toward the rear side, disengaged position. Specifically, the piston 34 receives, at its front face, the hydraulic pressure of the ATF introduced into the oil chamber 2c and at its rear face the hydraulic pressure of the ATF that is supplied to the rear side chamber 2a in the torque converter 10. Seal rings c1, c2 are disposed between sliding contact surfaces of the piston 34 and the support member 36 and between sliding contact surfaces of the piston 34 and the cylindrical portion 23b of the turbine hub 23, respectively. Thus, the sealing function of the seal rings c1, c2 allows the piston 34 to be axially displaceable (in the front-rear direction), between the engaged position and the disengaged position, according to the difference between the hydraulic pressure of the ATF in the oil chamber 2c disposed forwardly of the piston 34 and that in the rear side chamber 2a, the latter serving as the lock-up engagement pressure region disposed rearwardly of the piston 34.

The displacement selector mechanism 35 has a valve chamber 38 defined by the inner cylindrical surface of the cylindrical portion 23b of the turbine hub 23, the outer cylindrical surface of the shaft portion 23c of the turbine hub 23, and the inner cylindrical surface of the valve body 28. The valve body 28 has its closed end (bottom) welded to the outer cylindrical surface of the shaft portion 23c. The valve chamber 38 communicates with an oil passage a3 formed in the turbine hub 23 and the rear side chamber 2a via the thrust bearing b2. The valve chamber 38 communicates with the front side chamber 2b via a through hole 28a formed in the closed end of the valve body 28. Further, the valve chamber 38 communicates with the oil chamber 2c via an oil passage a4 formed as a gap between the front end (open end) of the cylindrical portion 23b of the turbine hub 23 and the rear end of the valve body 28. Specifically, the valve chamber 38 connects (branches) the oil chamber 2c with both the rear side chamber 2a (lock-up engagement pressure region) and the front side chamber 2b (lock-up discharge pressure region), i.e. provides communication between the oil chamber 2c and the two chambers 2a, 2b.

A circular ring-shaped selector valve member 39 is slidably accommodated in the valve chamber 38, while receiving, from mutually opposing directions, the hydraulic pressure of the ATF introduced into the valve chamber 38 from the rear side chamber 2a via the oil passage a3 and the hydraulic pressure of the ATF introduced into the valve chamber 38 from the front side chamber 2b via the through hole 28a. Specifically, the selector valve member 39 is displaceable between an engagement pressure position (the position shown in FIG. 3), in which the oil chamber 2c is in communication with the rear side chamber 2a, and a pressure discharge position (the position shown in FIGS. 1 and 2), in which the oil chamber 2c is in communication with the front side chamber 2b.

A coil spring 40 is disposed in the valve chamber 38 between the selector valve member 39 and the inside bottom surface of the valve body 28. The coil spring 40 urges the selector valve member 39 rearwardly in the direction of the pressure discharge position. The magnitude of the urging force of the coil spring 40 is set so that, in the sliding engagement state of the lock-up clutch 15, the sum of (1) the urging force of the coil spring 40 and (2) the force of the hydraulic pressure in the front side chamber 2b is greater than the force of the hydraulic pressure in the rear side chamber 2a. When the lock-up clutch 15 is in the completely engaged state, the force of the hydraulic pressure in the rear side chamber 2a is greater than the sum of the urging force of the coil spring 40 (under compression) and the force of the hydraulic pressure in the front side chamber 2b.

A protrusion 39a protrudes axially rearwardly from the rear end face of the selector valve member 39. When the selector valve member 39 is displaced to the pressure discharge position, the protrusion 39a forms a slight gap between an inner surface of the valve chamber 38 formed by the front face of the flange portion 23a of the turbine hub 23 and the selector valve member 39. When the selector valve member 39 is in the pressure discharge position, the ATF flows in the gap formed by the protrusion 39a from the rear side chamber 2a via the oil passage a3, urging the selector valve member 39 in the forward direction toward the engagement pressure position (FIG. 3).

Operations of the torque converter 10 as described above will next be described with emphasis on the action of the frictional contact mechanism 17 when the lock-up clutch 15 is in an engagement state (the sliding engagement state or the completely engaged state).

When the lock-up clutch 15 changes from its disengaged state shown in FIG. 1 to its sliding engagement (slip) state shown in FIG. 2, the ATF of the lock-up engagement pressure is supplied into the rear side chamber 2a and the clutch plate 27, receiving the hydraulic pressure of the ATF, is pressed forwardly. As a result, the clutch plate 27 is brought into the sliding engagement state, in which the friction member 29 makes sliding contact with the rear face of the front cover 11, while allowing a difference in rotation, and the rotation of the output shaft 9 of the engine is transmitted to the input shaft 24 of the speed change mechanism, while shafts 9 and 24 have different rotational speeds.

The clutch plate 27 rotates in an unstable friction sliding mode when the lock-up clutch 15 is in such a sliding engagement state and judder may result from vibration of the clutch plate 27 and vibration of the damper unit 16 connected to the clutch plate 27. If the judder is transmitted to the input shaft 24 of the speed change mechanism, it will be sensed by the driver. Therefore, it is preferable to reduce transmission of the judder to the input shaft 24 of the speed change mechanism.

In the present invention, when the lock-up clutch 15 is in the sliding engagement state, the frictional contact mechanism 17 reduces transmission of the judder to the input shaft 24 of the speed change mechanism as follows.

When the lock-up clutch 15 is in the sliding engagement state, the ATF of the lock-up engagement pressure flows into the valve chamber 38 from the rear side chamber 2a via the oil passage a3 in the displacement selector mechanism 35, so that the ATF pressure opposes the urging force of the coil spring 40 and the lock-up discharge pressure to press the selector valve member 39 forwardly toward the engagement pressure communication position. In this sliding engagement state, however, the sum of the urging force of the coil spring 40 urging the selector valve member 39 rearwardly in the direction of the discharge pressure communication position inside the valve chamber 38 and the force of the lock-up discharge pressure in the front side chamber 2b is greater than the force of the lock-up engagement pressure pressing the selector valve member 39 forwardly in the direction of the engagement pressure communication position inside the valve chamber 38. Accordingly, the selector valve member 39 would not be displaced from the discharge pressure communication position.

Accordingly, the oil chamber 2c between the piston 34 and the clutch plate 27 communicates with the front side chamber 2b and ATF at the lock-up discharge pressure flows into the oil chamber 2c. As a result, because the lock-up engagement pressure received by the rear face of the piston 34 is higher than the lock-up discharge pressure acting on its front face, the piston 34 is gradually moved forward. Then, the friction member 37 gradually comes into frictional contact with the rear face of the clutch plate 27. Through the action of the friction member 37, making frictional contact with the clutch plate 27, hysteresis in the lock-up clutch 15 increases to reduce transmission of judder to the speed change mechanism.

When the lock-up clutch 15 changes from the sliding engagement state shown in FIG. 2 to the completely engaged state shown in FIG. 3, the hydraulic pressure of the ATF (lock-up engagement pressure) supplied to the rear side chamber 2a is increased to more than that during the sliding engagement state. Consequently, the clutch plate 27 is pressed forward harder than in the sliding engagement state, to the extent of becoming integrally rotatable with the front cover 11 via the friction member 29. As a result, the lock-up clutch 15 is placed in the directly connected state (completely engaged state) to provide a mechanical connection (couple) between the output shaft 9 of the engine and the input shaft 24 of the speed change mechanism.

Because, in the completely engaged state of the lock-up clutch 15, the output shaft of the engine is directly connected with the input shaft 24 of the speed change mechanism, if torque fluctuations occur due to vibration deriving from ignitions of fuel in the engine, those torque fluctuations may be directly transmitted to the speed change mechanism and, accordingly, the lock-up clutch 15 includes the damper unit 16 for dampening torque fluctuations. However, when the piston 34 makes frictional contact with the clutch plate 27, the torque fluctuations are directly transmitted to the speed change mechanism via the piston 34. Therefore, in present invention, the friction contact mechanism 17 reduces transmission of the torque fluctuations to the input shaft 24 of the speed change mechanism in the completely engaged state of the lock-up clutch 15 as follows.

Specifically, when the lock-up clutch 15 is in the completely engaged state, as in the sliding engagement state, the ATF at the lock-up engagement pressure flows into the valve chamber 38 from the rear side chamber 2a via the oil passage a3 in the displacement selector mechanism 35, so that the ATF pressure opposes the force of the coil spring 40 and the lock-up discharge pressure to press the selector valve member 39 forwardly in the direction of the engagement pressure communication position. In this case, unlike the sliding engagement state, the sum of the urging force of the coil spring 40 urging the selector valve member 39 rearwardly in the direction of the discharge pressure communication position inside the valve chamber 38 and the force of the lock-up discharge pressure of the front side chamber 2b is smaller than the force of the lock-up engagement pressure pressing the selector valve member 39 forwardly in the direction of the engagement pressure communication position inside the valve chamber 38. The selector valve member 39 is therefore displaced to the engagement pressure communication position.

Accordingly, the oil chamber 2c, between the piston 34 and the clutch plate 27, comes into communication with the rear side chamber 2a and the ATF at the lock-up engagement pressure flows into the oil chamber 2c to make the oil chamber 2c oil-tight. As a result, because the piston 34 receives the lock-up engagement pressure on both its front face and its rear face, it is not displaced. At the same time, the clutch plate 27, receiving the lock-up engagement pressure in the rear side chamber 2a, is forced forward so as to become spaced apart from the piston 34. Consequently, the piston 34 is spaced from the clutch plate 27, i.e. the piston 34 and the clutch plate 27 are in a non-contact state relative to each other. Transmission of fluctuations in torque from the engine to the speed change mechanism is therefore reduced.

Accordingly, the above-described embodiment provides the following advantages.

(1) When the lock-up clutch 15 is in the sliding engagement state, the piston 34 of the frictional contact mechanism 17 makes frictional contact with the clutch plate 27 of the lock-up clutch 15 and the judder generated in the sliding engagement state is thereby converted to friction energy and dampened. Transmission of the judder, generated in the sliding engagement state of the lock-up clutch 15, to the input shaft 24 of the speed change mechanism is therefore reduced.

(2) When the lock-up clutch 15 is in the completely engaged state, the piston 34 of the frictional contact mechanism 17 is spaced from the clutch plate 27 of the lock-up clutch 15 and, therefore, the fluctuations in engine torque (or in other drive source) transmitted to the input shaft 24 of the speed change mechanism, via the frictional contact mechanism 17 from the lock-up clutch 15, are thereby reduced.

(3) The piston (displacement member) 34 can be displaced (moved by pressure) between the engagement position, at which the second piston 34 makes frictional contact with the clutch plate 27 (first piston) of the lock-up clutch 15, and the non-engagement (disengaged) position, which is spaced apart from the engagement position, by effectively using the hydraulic pressure of the ATF (hydraulic fluid) that flows through the torque converter 10 during engagement of the lock-up clutch 15. Thus, the piston 34 can easily be displaced between the engagement position and the non-engagement position, without need for any electric control mechanism, based on the pressure difference between the hydraulic pressure of the ATF acting on the front side of piston 34 and the hydraulic pressure of the ATF acting on the rear side of the piston 34.

(4) The hydraulic pressure of the ATF pressing the piston 34 from the engagement position toward the non-engagement position becomes the lock-up discharge pressure in the sliding engagement (slip) state of the lock-up clutch 15 and the lock-up engagement pressure in the completely engaged state of the lock-up clutch 15. The lock-up engagement pressure acts at all times on the piston 34 urging it from the non-engagement position toward the engagement position. In the sliding engagement state of the lock-up clutch 15, therefore, the piston 34 is pressed by the lock-up engagement pressure on a high pressure side and thereby moved to the engagement position where it is in frictional contact with the clutch plate 27 of the lock-up clutch 15. In the completely engaged state of the lock-up clutch 15, on the other hand, the same hydraulic lock-up engagement pressure acts on the piston 34 from both the side of the engagement position and the side of the non-engagement position, so that the piston 34 is not displaced. However, the clutch plate 27 of the lock-up clutch 15, under force of the lock-up engagement pressure, is displaced so as to become spaced apart from the piston 34 (non-contact state).

(5) In the sliding engagement (slip) state of the lock-up clutch 15, the sum of the urging force of the coil spring (biasing member) 40 biasing the selector valve member 39 in the direction of the discharge pressure communication position and the force of the lock-up discharge pressure becomes greater than the force of the lock-up engagement pressure urging the selector valve member 39 in the direction of the engagement pressure communication position. Since the selector valve member 39 is positioned at the discharge pressure communication position, the hydraulic pressure of the oil chamber 2c acting on the piston 34 from the side of the engagement position becomes the lock-up discharge pressure, so that the piston 34 is forced by the lock-up engagement pressure on the high pressure side to the engagement position. When in the completely engaged state of the lock-up clutch 15, on the other hand, the force of the lock-up engagement pressure urging the selector valve member 39 in the direction of the engagement pressure communication position becomes greater than the sum of the urging force of the coil spring 40 and the force of the lock-up discharge pressure. The selector valve member 39 is therefore moved to the engagement pressure communication position, so that the hydraulic pressure of the oil chamber 2c, acting on the piston 34 from the side of the engagement position, becomes the lock-up engagement pressure. In other words, the same lock-up engagement pressure acts on the piston 34 from both the side of the engagement position and the side of the non-engagement position and, accordingly, the piston 34 is not displaced by hydraulic pressure. At the same time, however, the clutch plate 27 of the lock-up clutch 15 that receives the lock-up engagement pressure is displaced so as to become spaced from the piston 34, so that the piston 34 is in a non-contact state relative to the lock-up clutch 15.

The above-described embodiment may be modified as follows.

In the above-described embodiment, a flat spring or a biasing member of any other type, may be used instead of the coil spring 40 as the biasing member.

In the above-described embodiment, instead of providing the valve chamber 38 with the coil spring 40, the selector valve member 39 may be designed so as, for example, to have front and rear faces with different areas for receiving the lock-up engagement pressure, so that there is a difference between the forces acting axially on the selector valve member 39 from the front and rear.

In the above-described embodiment, the displacement selector mechanism 35 may include a selector valve member 39 that is moved between the engagement pressure communication position and the discharge pressure communication position by an electromagnetic solenoid.

In the above-described embodiment, the piston 34 may be displaced by an electromagnetic solenoid, between the engaged position in which the piston 34 is in frictional contact with the clutch plate 27, and the disengaged position in which the piston 34 is spaced rearward from the engaged position.

In the above-described embodiment, the piston 34 need not necessarily have its non-engagement position spaced away from the clutch plate 27, if designed to make frictional contact with the clutch plate 27 in the sliding engagement state of the lock-up clutch 15. In such a modification, transmission of judder to the speed change mechanism, in the sliding engagement state of the lock-up clutch 15, can likewise be reduced.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A torque converter comprising:
a converter housing connected to an output shaft of a drive source;
a pump impeller connected to the converter housing;
a turbine runner connected to an input shaft of a speed change mechanism in opposition to the pump impeller;
a lock-up clutch including a first piston disposed between the turbine runner and the converter housing to provide direct connection between the output shaft and the input shaft when engaged; and
a friction contact mechanism for bringing a second piston into frictional contact with the first piston of the lock-up clutch when the lock-up clutch is in a sliding engagement state of sliding contact of the first piston with the converter housing, while allowing a difference in rotation therebetween.

2. The torque converter according to claim 1, wherein
when the lock-up clutch is in a completely engaged state of frictional contact with the converter housing and integrally rotatable therewith, the second piston is spaced apart from the first piston of the lock-up clutch.

3. The torque converter according to claim 2, wherein
the frictional contact mechanism includes:
the second piston that is displaceable between an engagement position in frictional contact with the first piston of the lock-up clutch, and a non-engagement position which is spaced from the engagement position; and
a displacement selector mechanism that controls movement of the second piston between its engagement and non-engagement positions by selectively applying hydraulic pressure, of a hydraulic fluid within the torque converter, on the second piston during operation of the lock-up clutch.

4. The torque converter according to claim 3, wherein
the displacement selector mechanism connects an oil chamber, containing hydraulic fluid exerting a hydraulic pressure biasing the second piston toward the non-engagement position, with a lock-up engagement pressure region when the lock-up clutch is in the sliding engagement state and with a lock-up discharge pressure region when the lock-up clutch is in its completely engaged state.

5. The torque converter according to claim 4, wherein
the displacement selector mechanism includes:
a valve chamber through which the oil chamber is selectively connected with the lock-up engagement pressure region or the lock-up discharge pressure region;
a selector valve member disposed in the valve chamber for sliding movement between an engagement pressure communication position at which the oil chamber is in communication with the lock-up engagement pressure region, and a discharge pressure communication position at which the oil chamber is in communication with the lock-up discharge pressure region, wherein the valve member in the discharge pressure position receives, from opposing directions, the hydraulic pressure of the lock-up engagement pressure region and the hydraulic pressure of the lock-up discharge pressure region; and
a biasing member that provides a force which, in cooperation with the hydraulic pressure of the lock-up discharge pressure region, urges the selector valve member toward the discharge pressure communication position; wherein the force of the biasing member is set so that, when the lock-up clutch is in its sliding engagement state, the sum of the force of the biasing member and the force of the hydraulic pressure in the lock-up discharge pressure region is greater than the force of the hydraulic pressure in the lock-up engagement pressure region; and wherein, when the lock-up clutch is in its completely engaged state, the force of the hydraulic pressure in the lock-up engagement pressure region is greater than the sum of the force of the biasing member and the force of the hydraulic pressure in the lock-up discharge pressure region.

6. The torque converter according to claim 1, wherein
the frictional contact mechanism includes:
the second piston that is displaceable between an engagement position in frictional contact with the first piston, and a non-engagement position which is spaced from the engagement position; and
a displacement selector mechanism that controls movement of the second piston between its engagement and the non-engagement positions by selectively applying hydraulic pressure, of a hydraulic fluid within the torque converter, on the second piston during operation of the lock-up clutch.

7. The torque converter according to claim 6, wherein
the displacement selector mechanism connects an oil chamber, containing hydraulic fluid exerting a hydraulic pressure biasing the second piston toward the non-engagement position, with a lock-up engagement pressure region when the lock-up clutch is in the sliding engagement state and with a lock-up discharge pressure region when the lock-up clutch is in its completely engaged state.

8. The torque converter according to claim 7, wherein
the displacement selector mechanism includes:
a valve chamber through which the oil chamber is selectively connected with the lock-up engagement pressure region or the lock-up discharge pressure region;
a selector valve member disposed in the valve chamber for sliding movement between an engagement pressure communication position at which the oil chamber is in communication with the lock-up engagement pressure region, and a discharge pressure communication position at which the oil chamber is in communication with the lock-up discharge pressure region, wherein the valve member in the discharge pressure position receives, from, from opposing directions, the hydraulic pressure of the lock-up engagement pressure region and the hydraulic pressure of the lock-up discharge pressure region; and
a biasing member that provides a force which, in cooperation with the hydraulic pressure of the lock-up discharge pressure region, urges the selector valve member toward the discharge pressure communication position; wherein the force of the biasing member is set so that, when the lock-up clutch is in its sliding engagement state, the sum of the force of the biasing member and the force of the hydraulic pressure in the lock-up discharge pressure region is greater than the force of the hydraulic pressure in the lock-up engagement pressure region; and wherein, when the lock-up clutch is in its completely engaged state, the force of the hydraulic pressure in the lock-up engagement pressure region is greater than the sum of the force of the biasing member and the force of the hydraulic pressure in the lock-up discharge pressure region.

9. The torque converter according to claim 3 wherein the oil chamber is defined between the first and second pistons.

10. The torque converter according to claim 7 wherein the oil chamber is defined between the first and second pistons.

11. The torque converter according to claim 5 wherein the biasing member is a spring.

12. The torque converter according to claim 8 wherein the biasing member is a spring.
